(19) United States
(12) Patent Application Publication
(10) Pub. No.: US 2025/0289020 A1
(43) Pub. Date: Sep. 18, 2025

(54) DEVICE FOR ACTUATING A CARTRIDGE

(71) Applicants: JOST-WERKE DEUTSCHLAND GMBH, Neu-Isenburg (DE); TRIBOSERV GMBH & CO. KG, Geldersheim (DE)

(72) Inventors: Michael WEIGAND, Geldersheim (DE); Johannes APPELMANN, Heusenstamm (DE); Benjamin KAUFHOLD, Seeburg (DE)

(21) Appl. No.: 19/077,436

(22) Filed: Mar. 12, 2025

(30) Foreign Application Priority Data
Mar. 13, 2024 (DE) 102024107124.9
Jun. 12, 2024 (DE) 102024116438.7

(51) Int. Cl. B05C 5/02; F16N 7/14

(52) U.S. Cl. CPC B05C 5/0225; F16N 7/14

(57) ABSTRACT

An actuating device for a cartridge including a housing in which a linearly acting drive is arranged including a drive motor and transmission including a drive spindle and spindle nut, the drive motor is engaged with the spindle nut for transmitting rotational movement, the drive spindle reciprocates over a stroke upon rotation of the spindle nut relative to the housing, the housing includes a wall through which the drive spindle can be passed with a first axial end, the drive spindle can be brought into direct or indirect engagement with a displacement element of the cartridge at the first axial end, the drive spindle includes a first rotation-preventing element along a section in the housing, a second rotation-preventing element associated with the housing is provided, and the drive spindle is supported non-rotatable against the housing over at least part of the stroke. A combination of a device and a cartridge.

### FIELD OF THE INVENTION

The invention relates to a device for actuating a cartridge, hereinafter also referred to as an actuating device, for dispensing a viscous medium, in particular for dispensing and/or metering a lubricant to a lubrication point. The invention also relates to a combination of such a device and a cartridge, hereinafter also referred to as a lubricant dispenser.

### BACKGROUND OF THE INVENTION

The invention relates, in the narrower sense, to electromechanical lubricators with lubricant cartridges and an electric motor drive for actuating the same. In electromechanical lubricators, a spindle drive is usually used as the transmission element to convert the torque from the drive motor into an axial propulsive movement of a displacement element or piston. The dosing of the lubricant is realized, for example, by a microcontroller-controlled drive depending on the lubricant requirement as well as external influences, such as temperature.

Electronic dosing devices for medical, molecular biological and pharmaceutical applications are known, for example, from document EP 3 399 214 A1. WO 2022/117 890 A1 deals with robot-operated dispensing systems. Other automatic dosing devices for liquid and pasty media in industrial applications are known from documents DE 41 07 479 A1, US 2023/0 026 919 A1 or DE 102 34 881 A1. Document US 2002/0 120 235 A1 discloses a manually operated applicator pen for administering doses of medication. Document DE 10 2009 027 783 A1 discusses a hand-held applicator that can optionally be motor-assisted. The subject of EP 0 598 867 B1 is a gas-pressure-operated device for the targeted delivery of a liquid or viscous medium. JP H11-235 546 A discloses a syringe driven by a stepper motor. Document US 11 746 656 B1 discloses a micro-metering pump for the application of small quantities of liquid materials, in particular for use in the assembly of electronic components.

The invention can be used, for example, in media lubrication, which regularly involves small dosages of lubricant and where automation is therefore helpful. Other applications are in locations that are difficult for people to access or where access is restricted.

Actuating devices and lubricators of this kind are known, for example, from the publications DE 20 2012 100 014 U1, DE 43 21 452 C1, DE 10 2005 016 259 A1, DE 44 22 407 A1 or DE 92 14 096 U1 The known devices uniformly comprise a housing with a linearly acting drive, wherein the drive comprises a drive motor and a transmission and wherein the transmission includes at least one drive spindle. DE 44 22 407 A1 and DE 9 214 096 U1 discuss solutions in which the drive motor acts on the drive spindle via further gear components and sets it in rotation. At the lower end of the housing, there is a cartridge that is either screwed on by means of a thread or connected in one piece to the drive housing. This cartridge has a containing space, a dispensing opening at the lower end and a displacement element or piston for dispensing the viscous medium through a dispensing opening. The piston comprises a threaded element that interacts with the rotatably driven drive spindle of the device in such a way that the piston, which is positioned in the cartridge in a rotationally fixed manner, is moved up or down depending on the direction of rotation when the spindle is turned. Since the piston is connected to the drive spindle by means of the screw thread, either the piston together with the spindle is assigned to the cartridge, as shown in document DE 44 22 407 A1, or both together are assigned to the actuating device, as shown in document DE 9 214 096 U1.

In contrast to this, document DE 10 2005 016 259 A1 shows a solution with a non-exchangeable cartridge that contains a piston without a drive spindle as a structural component. This is made possible by reverse kinematics of the drive. A spindle not shown in the document is moved downwards by a rotatably driven spindle nut. During the downward movement, the spindle presses on the piston mounted in the cartridge, moving it in the direction of the discharge opening to dispense the lubricant. After a lock has been achieved, the cartridge can be easily removed in the axial direction opposite to the operating direction.

Under load, the axial pressure on the drive spindle increases. This initially prevents the drive spindle from turning with the spindle nut. However, if the torque transmitted by the spindle nut to the drive spindle during rotation exceeds a certain value, the drive spindle tends to rotate with the spindle nut, which means that when the drive is actuated, the axial forward movement of the drive spindle and the lubricant discharge are no longer guaranteed. Conversely, the drive spindle may also tend to turn if the friction locking of the drive spindle without load is too low. This may be the case, for example, if the drive spindle has been completely unscrewed out of the housing after the cartridge has been emptied and now has to be turned back.

On the other hand, it is very helpful for the drive spindle to be able to turn freely, especially in the case of lubricators with replaceable cartridges, where the cartridge is generally fixed to the housing of the actuating device with a screw connection. When screwing the cartridge onto the housing of the device, contact between the drive spindle and the displacement element occurs at some point, which may make it necessary to rotate the drive spindle in order to avoid damage to the cartridge or the actuating device.

### SUMMARY OF THE INVENTION

The object of the present invention is therefore to make the device mentioned above for actuating a cartridge (actuating device) and the combination (lubricator) more reliable in operation.

The object is achieved by a device for actuating a cartridge for dispensing a viscous medium, comprising a housing in which a linearly acting drive is arranged, wherein the drive comprises a drive motor and a transmission, wherein the transmission comprises a drive spindle and a spindle nut, wherein the drive motor is in direct or indirect engagement with the spindle nut for transmitting a rotary motion, wherein the drive spindle defines a drive axis about which the spindle nut is rotatably arranged and along which the drive spindle is arranged to reciprocate over a stroke upon rotation of the spindle nut relative to the housing, wherein the housing comprises a wall through which the drive spindle can be passed with a first axial end, wherein the drive spindle can be brought into engagement at the first axial end with a displacement element (piston) of the cartridge, wherein the drive spindle comprises a first rotation-preventing element along a section in the housing, wherein a second rotation-preventing element associated with the housing is provided, and wherein the first rotation-preventing element and the second rotation-preventing element interact in shape such that the spindle is non-rotatably abutted against the housing at least over part of the stroke.

The housing, hereinafter also referred to as the drive housing, typically encloses a space in which both the drive motor and the transmission and, if present, an electronic control system for the drive motor can be accommodated. The drive spindle is optionally guided out of the housing at its first axial end in the retracted state and in any case in the extended state, i.e. a section of the drive spindle protrudes out of the housing through the wall. The remaining section of the drive spindle always remains within the housing.

The first rotation-preventing element is located at least along the portion of the drive spindle that always remains in the housing. The second rotation-preventing element associated with the housing engages the first rotation-preventing element at least over part of the stroke and preferably over the entire stroke, whereby the drive spindle is supported in a non-rotatable manner.

When the drive spindle is engaged at its first axial end with the cartridge's displacement element and is pressed against it in order to drive the displacement element into the cartridge, it is supported in the axial direction against the spindle nut. The spindle nut is supported for this purpose against a structural component, for example a carrier plate, in the housing. In order to enable low-wear rotation of the spindle nut even under load, a sliding element is preferably located between the spindle nut and the structural component, which can be loosely inserted there or attached to the spindle nut or to the structural component.

Preferably, the first rotation-preventing element and the second rotation-preventing element form a form fit or a force fit.

Analogous to a clutch, the first and second rotation-preventing elements, which interact in the housing, connect the drive spindle and the housing either rigidly or, preferably, with limited torque transmission, analogous to a slip clutch. The term “anti-rotation device” as used in this document is therefore not limited to a rigid connection, but also includes connections that allow the drive spindle to rotate relative to the housing when a certain torque occurs or is exceeded. A torque limiter with limited torque transmission is therefore preferred over a rigid anti-rotation device in cases where it is necessary to ensure that the transmission and/or the drive motor are protected from damage when high torques occur. This may be necessary, for example, when unscrewing a detachably connected cartridge, as described above.

A force-locking rotation lock-analogous to a friction clutch—can be realized, for example, by pressing a friction element onto the outer circumference of the drive spindle as a second rotation-preventing element, in addition to the first rotation-preventing element. Depending on the contact pressure, size of the friction surface and material pairing, the spindle can be held in this way up to a certain torque. According to an alternative solution, the friction element can also be configured similarly to a self-locking nut so that it interacts with parts of the thread flanks or with the complete thread profile in a frictional or force-locking manner on an axial section of the threaded spindle.

An anti-rotation device with limited torque transmission can be achieved not only by means of a force-locking connection, but also by means of a form-fit. In such cases, the first rotation-preventing element and the second rotation-preventing element preferably form a form fit, wherein the second rotation-preventing element is elastically deformable against a restoring force or can be moved away from the first rotation-preventing element, thereby releasing the form fit.

A form fit can preferably be achieved by configuring the first rotation-preventing element in the form of one or more flat portions along the section on the drive spindle and by the second rotation-preventing element comprising one or more guide elements that directly or indirectly abut the flat portion or flat portions and are connected to the housing.

Alternatively or additionally, the first rotation-preventing element can be configured in the form of one or more recesses along the section in the drive spindle and the second rotation-preventing element comprises one or more projections that engage in the recess or recesses and are indirectly or directly connected to the housing.

The flat or flats along the section of the drive spindle are also referred to hereinbelow as the spanner flat or flats. Two guide elements of the second rotation-preventing element form a matching spanner mouth which engages around the spanner flats of the drive spindle. The recess or recesses can be realized in the form of notches or grooves or openings. The projection or projections of the second rotation-preventing element can be formed by pins engaging in the recesses.

The guide element connected to the housing is preferably configured such that it can be moved away from the first rotation-preventing element in an elastic manner against a restoring force.

In a combination of the device with a cartridge (lubricant dispenser) according to the invention, the cartridge comprises a containing space for receiving the viscous medium, a dispensing opening for the viscous medium and a displacement element or piston associated with the containing space for conveying the viscous medium from the containing space through the dispensing opening.

The cartridge can be molded as a single piece onto the housing.

However, the cartridge is preferably detachably connected to the housing. Accordingly, the housing preferably comprises a connecting element for detachable connection to a cartridge.

It is particularly preferred that the cartridge be connectable to the housing by means of a screw connection or a bayonet connection. Accordingly, the connecting element is preferably configured in the form of a thread or an element of a bayonet lock. A complementary connecting element in the form of a thread or an element of a bayonet lock is therefore arranged on the cartridge.

According to a preferred embodiment of the device, the drive spindle comprises a coupling element at its first axial end for connection to the displacement element or piston of the cartridge.

The coupling element is further preferably connected to the drive spindle in a rotationally fixed manner and comprises a first stop element, radially spaced from the drive axis, for engagement with the displacement element or piston.

In this way, the device is advantageously configured to interact in combination with a cartridge whose displacement element also comprises a second stop element that is radially spaced from the drive axis, wherein the first stop element and the second stop element interact in such a way that the coupling element can be supported against the displacement element in a non-rotatable manner.

In this embodiment, the combination or the lubricant dispenser provides a dual rotation lock that works as follows: In the case of lower torques, for example when the coupling element has no or only light contact with the displacement element, the drive spindle is held by means of the first rotation-preventing element and the second rotation-preventing element and is moved as a result of the rotation of the spindle nut. As soon as the coupling element exerts axial pressure on the displacement element, the torque transmitted from the spindle nut to the drive spindle increases until the above-described anti-rotation device with limited torque transmission clears the drive spindle, allowing it to rotate with the spindle nut. This initially prevents further axial extension of the drive spindle. However, the drive spindle only turns until the first stop element of the coupling element and the second stop element of the displacement element engage. From this moment on, the coupling element abuts against the displacement element via the first stop element and the second stop element. The displacement element, in turn, is supported against the cartridge wall, for example, by frictional contact or by form fit, so that further rotation of the drive spindle is effectively prevented. The drive spindle is then further extended in the axial direction with the coupling element, and the displacement element is thus pushed forward into the containing space of the cartridge, whereby the viscous medium is pressed out of the containing space through the dispensing opening.

In an advantageous further development of the invention, the device comprises a motor control connected to the drive motor, which includes a sensor system for determining an upper and/or a lower end position of the drive spindle.

The sensor system can, for example, be configured by means of electronic measuring equipment for determining the current or power consumption of the drive motor and thus for indirectly determining the required torque. Alternatively or additionally, the sensor system can comprise one or more non-contact or mechanical position switches.

Furthermore, the motor control is arranged to switch off the drive motor when the upper or lower end position is determined or to reverse the direction of rotation of the drive motor.

This ensures that the drive motor can always move the drive spindle out of the respective end position.

The device also preferably comprises an elastic element that is arranged in such a way that it is indirectly or directly biased between the drive spindle and the housing in an upper end position of the drive spindle that is retracted into the housing with respect to the axial direction.

The elastic element ensures that the torque required to drive the drive spindle when the end position is reached increases slowly or in a defined manner, so that the end position can be reliably determined by determining the current or power consumption and the drive spindle is prevented from getting stuck in the end position so that the torque of the motor is no longer sufficient to move it out of this position.

For this purpose, the elastic element can preferably be arranged between the coupling element and a first wall section of the housing. Alternatively or additionally, the elastic element can be located between a second axial end of the drive spindle and a second wall section of the housing.

### BRIEF DESCRIPTION OF THE DRAWINGS

The invention will be further explained below with reference to the drawings. It is shown in

FIG. 1 a cross-sectional view of the combination according to the invention in a first cross-sectional plane;

FIG. 2 the combination according to the invention in FIG. 1 in perspective cross-sectional views in a second plane;

FIG. 3 a perspective view of the device according to the invention, looking at the connection side to the cartridge; and

FIG. 4 a perspective view of the cartridge, looking at the connection side to the device according to the invention.

### DETAILED DESCRIPTION OF THE INVENTION

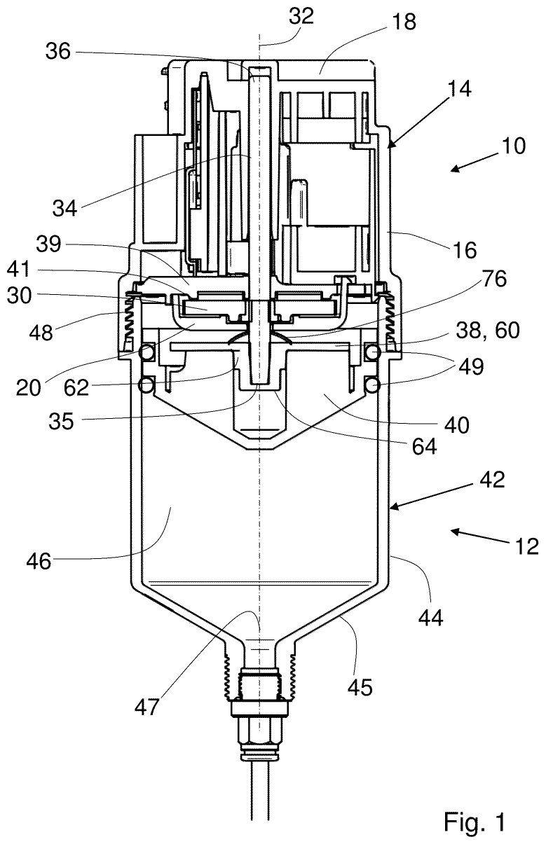

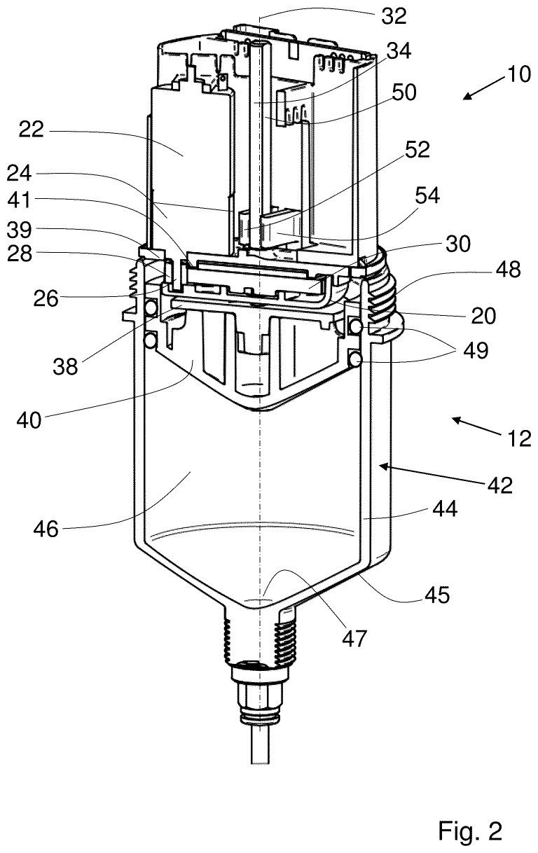

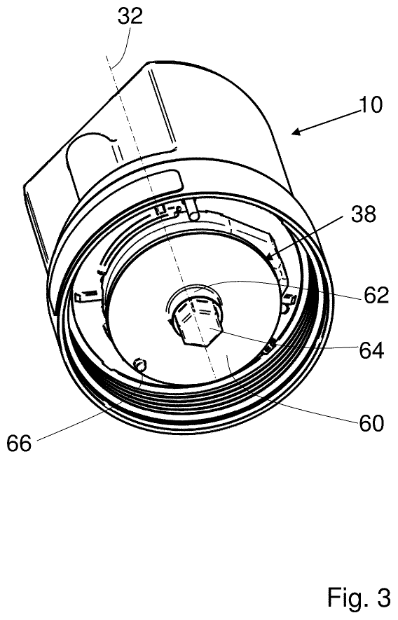

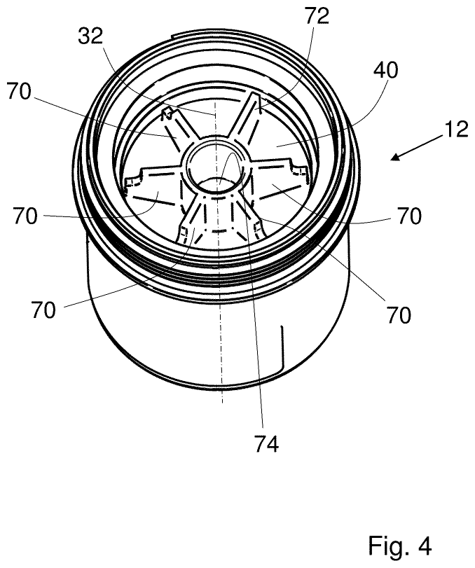

The same assembled combination of an actuating device 10 and a cartridge 12 is shown in FIGS. 1 and 2. The actuating device 10 comprises a housing 14 having a peripheral housing wall 16, a housing cover 18, also referred to as a second wall section of the housing, and a housing base 20, also referred to as the first wall section of the housing, wherein in the illustration of FIG. 2, the housing 14 of the actuating device 10, with the exception of the housing base 20, has been left out to make the internal elements more visible. FIG. 3 shows the actuating device according to the invention separately. FIG. 4 also shows the cartridge from FIGS. 1 and 2 separately.

A linearly acting drive, consisting of a drive motor 22 and a transmission, is arranged in the housing 14. The transmission includes a motor transmission 24 connected directly to the drive motor. An output shaft 26 extends out of the common housing. A spur gear 28 is mounted on the output shaft 26, which transmits the rotation of the output shaft 26 to a spindle nut 30 with a peripheral gear rim. Along a drive axis 32, a drive spindle 34 extends as a further part of the transmission, interacting with the spindle nut. The spindle nut 30 thus turns around this drive axis 32.

The drive spindle 34 is guided out of the housing 14 of the actuating device 10 through the housing base 20 by its first axial end 35. A coupling element 38 is arranged on the first axial end 35 of the drive spindle 34 and is connected to the drive spindle 34 in a rotationally fixed manner. In the assembled state shown in FIGS. 1 and 2, the drive spindle 34 is indirectly engaged with a displacement element or piston 40 of the cartridge 12 via the coupling element 38.

A carrier plate 39 is located in the housing 14, against which the spindle nut 30 abuts under load. The housing base 20 is suspended in the carrier plate 39 from below. Its object is to protect the spindle nut 30 from below and to hold it in position. The object of the housing base 20 is not to divert the axial force acting on the spindle nut under load into the structure of the housing. Between the spindle nut 30 and the carrier plate 39 is a sliding element 41 for low-wear rotation of the spindle nut even under load.

The cartridge 12 further comprises a cartridge wall 42 having a peripheral wall 44 and a bottom wall 45 opposite the displacement element or piston 40. The cartridge wall 42 together with the piston 40 encloses a containing space 46 for receiving the viscous medium not shown. A dispensing opening 47 is located in the bottom wall 45. When the piston 40 is moved by means of the drive out of the position shown in FIGS. 1 and 2 and towards the bottom wall 45, the viscous medium is conveyed out of the cartridge 12 through the dispensing opening 47.

The housing 14 of the actuating device 10 and the wall 42 of the cartridge 12 are designed in two parts and are detachably connected to each other by means of a screw connection 48. The screw connection 48 is only one possible embodiment of a detachable connection between the actuating device 10 and the cartridge 12. In its place, for example, a bayonet connection, a latching connection or another self-locking plug connection can be provided.

The piston 40 is sealed with respect to the cylindrical inner surface of the peripheral wall 44 of the cartridge 12 by means of a double O-ring seal 49, so that the viscous medium cannot escape upwards in the direction of the actuating device 10 when pressure is applied. Furthermore, the double O-ring seal 49 effects a rotational lock of the piston 40 with respect to the cartridge wall 42 and the housing 14 of the actuating device 10 connected thereto.

In order to prevent the drive spindle 34 from turning with the rotating spindle nut 30 when there is no load or only a low load, the spindle nut comprises a first rotation-preventing element in the form of two opposing flat or spanner flats 50 along a section in the housing 14. Two guide elements 52, 54, which are connected to the housing 14 and abut opposite one another on both sides of the drive spindle 34, abut against the spanner flats 50, forming the second rotation-preventing element. The two guide elements 52, 54 form a fork-shaped arrangement with a kind of key mouth in their space, which engages around the spanner flats 50 of the drive spindle 34 in a form-fitting manner. The guide elements 52 and 54 are designed so that, with respect to the drive axis 32, they can deflect elastically radially outwards if the torque exerted by the drive spindle 34 via the spanner flats 50 exceeds a certain value. Elastic deflection means that the guide elements 52 and 54 of the radially outwardly oriented movement oppose a restoring force which moves them back to the initial state after the cause of the movement has ceased to exist. This ensures that the drive spindle 34 can rotate with the spindle nut 30, for example, when the cartridge 12 is screwed to the housing 10 of the actuating device and a correspondingly high torque is transmitted to the drive spindle. The first rotation-preventing element and the second rotation-preventing element thus form a rotation-preventing device with limited torque transmission.

The coupling element 38 is a predominantly cylindrically symmetrical element with a disk 60, in axial continuation of a cylindrical extension 62 and in turn in axial continuation of a hexagonal element 64, which can be actuated with a standard key, for example, to manually move the drive spindle up or down. In the cylindrical extension 62 and the hexagonal element 64, there is a bore from the side of the coupling element 38 facing the housing 14, into which the drive spindle 34 is pressed for the purpose of force closure, thus creating a rotationally fixed connection between the drive spindle 34 and the coupling element 38. In order to ensure linear drive of the piston 40 at high loads despite the anti-rotation device with limited torque transmission, the drive spindle 34 must be prevented from turning further during operation. For this purpose, the coupling element 38 comprises a first stop element 66 on its underside facing the cartridge, radially spaced from the drive axis 32.

The displacement element 40 comprises on its upper side facing the actuating device 10 a plurality of radially arranged stiffening ribs 70, of which a stiffening rib 72 forms a second stop element of the piston 40. On their upper side facing the Actuating Device 10, the stiffening ribs 70, 72 define a flat bearing surface perpendicular to the drive axis 32, on which the disc 60 of the coupling element 38 rests. The cylindrical extension 62 is then centered in a center bore 74 in the piston 40.

The second stop element 72 differs from the remaining stiffening rib 70 in that the latter comprises clearances in each of the radially outer areas, which allow the first stop element 66 to pass during a relative rotation of the coupling element 38 to the piston 40. Depending on the direction of rotation of the drive spindle 34, the first stop element 66 strikes either on the left or on the right against the continuous stiffening rib 72 after a maximum of approximately one complete revolution. The first stop element 66 and the second stop element 72 then interact in such a way that the coupling element 38 is non-rotatably abutted against the displacement element 40.

Both the housing 14 of the actuating device 10 and the wall 42 of the cartridge 12 comprise a substantially circular cylindrical basic shape, the longitudinal axis of which coincides with the drive axis 32 of the drive spindle 34. This ensures that when the cartridge 12 is screwed into the housing 14 of the actuating device 10, the piston 40 rotates around the drive axis 32 and thus transmits a torque around this axis via the coupling element 38 to the drive spindle 34 as soon as the disc 60 rests on the flat bearing surface. The rotation lock with limited torque transmission releases the drive spindle for rotation when the preset limit torque is exceeded, so that the cartridge and the actuating device are not damaged when screwed together.

In addition to the drive motor and the transmission, the housing 14 of the actuating device 10 contains a not shown motor control connected to the drive motor, the motor control including an electronic sensor system for determining the upper and lower end positions of the drive spindle 34. The upper end position is defined by an elastic element in the form of a spring washer 76 between the coupling element 38 and the housing base 20. The spring washer 76 is biased between the coupling element 38 and the housing 14 and thus indirectly between the drive spindle 34 and the housing 14 as the drive spindle 34 approaches its upper end position with respect to the axial direction. As a result, the torque required for the drive initially increases linearly, causing the sensor system of the motor control to register an increased power consumption of the drive motor 22 and to switch it off when a pre-set limit value is reached.

Instead of arranging an elastic element between the coupling element 38 and the second section 20 of the housing 14, an elastic element can alternatively or additionally be provided between a second axial end 36 of the drive spindle 34 and the second wall section of the housing 14, that is to say the housing cover 18.

### LIST OF REFERENCE SIGNS

10 Actuating device
12 Cartridge
14 Housing of the actuating device
16 Peripheral housing wall
18 Housing cover, second wall section of the housing
20 Housing base, first wall section of the housing
22 Drive motor
24 Motor transmission
26 Output shaft of the motor transmission
28 Spur gear
30 Spindle nut
32 Drive axis
34 Drive spindle
35 First axial end of the drive spindle
36 Second axial end of the drive spindle
38 Coupling element
39 Carrier plate
40 Displacement element, piston
41 Sliding element
42 Cartridge wall
44 Peripheral wall
45 Bottom wall
46 Containing space
47 Dispensing opening
48 Screw connection
49 O-ring seal
50 Flattening, spanner flat
52 Guide element
54 Guide element
60 Disk of the coupling element
62 Cylindrical extension
64 Hexagonal element
66 First stop element
70 Stiffening rib
72 Second stop element, stiffening rib
74 Center bore
76 Elastic element, spring washer

What is claimed is:

1. A device for actuating a cartridge for dispensing a viscous medium, the device comprising;
a housing in which a linearly acting drive is arranged,
wherein the drive comprises a drive motor and a transmission,
wherein the transmission comprises a drive spindle and a spindle nut,
wherein the drive motor is directly or indirectly engaged with the spindle nut for transmitting rotational movement,
wherein the drive spindle defines a drive axis about which the spindle nut is rotatably arranged and along which the drive spindle is arranged to reciprocate over a stroke upon rotation of the spindle nut relative to the housing,
wherein the housing comprises a wall through which the drive spindle can be passed with a first axial end,
wherein the drive spindle can be brought into direct or indirect engagement with a displacement element of the cartridge at the first axial end,
wherein the drive spindle comprises a first rotation-preventing element along a section in the housing,
wherein a second rotation-preventing element associated with the housing is provided, and wherein the first rotation-preventing element and the second rotation-preventing element interact in such a way that the drive spindle is supported in a non-rotatable manner against the housing over at least part of the stroke,
wherein the first rotation-preventing element and the second rotation-preventing element establish a form fit, wherein the second rotation-preventing element is elastically deformable or elastically movable away from the first rotation-preventing element against a restoring force and the form fit can be thereby released.

2. The device according to claim 1, wherein the first rotation-preventing element is configured in the form of one or more flattened portions or one or more recesses, and wherein the second rotation-preventing element comprises one or more guide elements abutting against the flattened portions or one or more projections engaging in the recesses.

3. The device according to claim 1, wherein the housing comprises a connecting element for releasable connection to a cartridge.

4. The device according to claim 1, wherein the drive spindle comprises a coupling element at the first axial end for connection to the displacement element of the cartridge.

5. The device according to claim 4, wherein the coupling element is connected to the drive spindle in a rotationally fixed manner and comprises a first stop element radially spaced from the drive axis for engagement with the displacement element.

6. The device according to claim 1, wherein the device comprises a motor control connected to the drive motor, which comprises a sensor system for determining an upper and a lower end position of the drive spindle.

7. The device according to claim 6, wherein the motor control is arranged to switch off the drive motor or to reverse the direction of rotation of the drive motor when the upper or lower end position is determined.

8. The device according to claim 1, wherein the device comprises an elastic element which is arranged in such a way that, in an upper end position of the drive spindle in which it is retracted into the housing, it is biased indirectly or directly between the drive spindle and the housing with respect to the axial direction.

9. The device according to claim 8, wherein the elastic element is arranged between a second axial end of the drive spindle and a second wall section of the housing.

10. The device according to claim 8, wherein the elastic element is arranged between the coupling element and a first wall section of the housing.

11. A device for actuating a cartridge for dispensing a viscous medium, the device comprising:
a housing in which a linearly acting drive is arranged,
wherein the drive comprises a drive motor and a transmission,
wherein the transmission comprises a drive spindle and a spindle nut,
wherein the drive motor is directly or indirectly engaged with the spindle nut for transmitting rotational movement,
wherein the drive spindle defines a drive axis about which the spindle nut is rotatably arranged and along which the drive spindle is arranged to reciprocate over a stroke upon rotation of the spindle nut relative to the housing,
wherein the housing comprises a wall through which the drive spindle can be passed with a first axial end,
wherein the drive spindle can be brought into direct or indirect engagement with a displacement element of the cartridge at the first axial end,
wherein the drive spindle comprises a first rotation-preventing element along a section in the housing,
wherein a second rotation-preventing element associated with the housing is provided, and wherein the first rotation-preventing element and the second rotation-preventing element interact in such a way that the drive spindle is supported in a non-rotatable manner against the housing over at least part of the stroke,
wherein an elastic element is arranged such that, in an upper end position of the drive spindle in which it is retracted into the housing, it is indirectly or directly biased between the drive spindle and the housing with respect to the axial direction.

12. A device for actuating a cartridge for dispensing a viscous medium, comprising:
a housing in which a linearly acting drive is arranged,
wherein the drive comprises a drive motor and a transmission,
wherein the transmission comprises a drive spindle and a spindle nut,
wherein the drive motor is directly or indirectly engaged with the spindle nut for transmitting a rotational movement,
wherein the drive spindle defines a drive axis about which the spindle nut is rotatably arranged and along which the drive spindle is arranged to reciprocate over a stroke upon rotation of the spindle nut relative to the housing,
wherein the housing comprises a wall through which the drive spindle can be passed with a first axial end,
wherein the drive spindle can be brought into engagement, indirectly or directly, with a displacement element of the cartridge at the first axial end,
wherein the drive spindle comprises a first rotation-preventing element along a section in the housing,
wherein a second rotation-preventing element associated with the housing is provided, and wherein the first rotation-preventing element and the second rotation-preventing element interact in such a way that the drive spindle is supported in a non-rotatable manner against the housing over at least part of the stroke,
wherein the drive spindle comprises a coupling element at the first axial end for connection to the displacement element of the cartridge, and
wherein the coupling element is connected to the drive spindle in a rotationally fixed manner and comprises a first stop element radially spaced from the drive axis for engagement with the displacement element.

13. A combination of the device according to claim 1, and a cartridge, wherein the cartridge comprises a containing space for receiving the viscous medium, a dispensing opening for the viscous medium and a displacement element associated with the containing space for conveying the viscous medium out of the containing space through the dispensing opening.

14. The combination according to claim 13, wherein the cartridge is integrally formed in one piece with the housing.

15. The combination according to claim 13, wherein the cartridge is detachably connectable to the housing.

16. The combination according to claim 15, wherein the cartridge is connectable to the housing by means of a screw connection or a bayonet connection.

17. The combination according to claim 13, wherein the drive spindle comprises a coupling element at the first axial end for connection to the displacement element of the cartridge,
wherein the coupling element is connected to the drive spindle in a rotationally fixed manner and comprises a first stop element radially spaced from the drive axis,
wherein the displacement element comprises a second stop element radially spaced from the drive axis, and
wherein the first stop element and the second stop element are arranged to interact such that the coupling element is supported against the displacement element in a non-rotatable manner.
